(19) United States
(12) Patent Application Publication
(10) Pub. No.: US 2011/0047012 A1
(43) Pub. Date: Feb. 24, 2011

(54) METHOD AND SYSTEM FOR PROMOTING A BUSINESS TO MEMBERS OF A SOCIAL NETWORK

(75) Inventor: Slade Sherman, Caulfield South (AU)

Correspondence Address: KLARQUIST SPARKMAN, LLP, 121 SW SALMON STREET, SUITE 1600, PORTLAND, OR, 97204, US

(73) Assignee: Myzerr Pty Limited, Dandenong (AU)

(21) Appl. No.: 12/860,842

(22) Filed: Aug. 20, 2010

(30) Foreign Application Priority Data
Aug. 20, 2009 (AU) 2009903927

(51) Int. Cl. G06Q 30/00

(52) U.S. Cl. 705/14.1; 705/14.49

(57) ABSTRACT

Methods and systems for promoting a business to members of a social network are disclosed. One embodiment is a method for promoting a business to users of a social network, the method including the following steps: establishing a closed user group comprising a plurality of users of the social network, wherein eligibility for membership of the closed user group requires satisfying at least one eligibility criterion; registering as a member of the social network a business wishing to promote a good or service to members of the closed user group, a business registration request including at least one discount offered by the business to members of the closed user group; and displaying discounts offered to the closed user group to any user who is a member of the closed user group.

### FIELD OF THE INVENTION

The present invention relates generally to methods and systems for delivering advertising content, and more specifically, to a system and method for delivering targeted advertising and promotional content to users of social networks.

### BACKGROUND TO THE INVENTION

Social network services facilitate the development of online communities of people who share interests and/or activities, by enabling them to build relationships, and exchange information and content. Many social network services are web based and provide a variety of means facilitating communication between users, including email and instant messaging services.

Online social network services generally provide users with a set of tools including the ability for a member to establish and customize a personal profile, an ability for members to provide comment, privacy settings to control who can view particular aspects of the users personal profile, a facility to block communications by unwanted members, and other features which enable creation of blog type entries and photo albums.

Due to the popularity of online social networks, they would provide an opportunity for advertisers, if efficient and effective means could be provided for management and delivery of advertisements and other promotional materials to users.

### SUMMARY OF THE INVENTION

According to an aspect of the present invention, there is provided a method for promoting a business to users of a social network, the method including the following steps:

establishing a closed user group comprising a plurality of users of the social network, wherein eligibility for membership of the closed user group requires satisfying at least one eligibility criterion;

registering as a member of the social network a business wishing to promote a good or service to members of the closed user group, a business registration request including at least one discount offered by the business to members of the closed user group; and

displaying discounts offered to the closed user group to any user who is a member of the closed user group.

In an embodiment, the method further includes the step of generating a discount coupon to be redeemed upon a member of the closed user group purchasing the good or service from the business.

The method may further include the steps of the user selecting a discount of interest and downloading a discount coupon for printing or storage on a personal storage device to facilitate subsequent redemption.

In a preferred form of the invention, the method further includes the step of the user indicating one or more user preferences including at least one category in relation to which the user wishes to receive notification of discounts.

The method may further include the step of broadcasting notifications of discounts to the members of a closed user group in accordance with user preferences associated with each member.

In one form of the invention, the user preferences include a location associated with the user so that only notifications relating to discounts relevant to the location associated with the user will be provided to the user.

Furthermore, in the event that no discounts matching the user preferences are identified, the method further includes the step of the user being presented with an option to invite a local business to become a member of the social network and offer a discount to the closed user group.

A user who invites a business to become a member of the social network may receive one or more social credits.

According to another aspect of the present invention, there is provided a system for promoting a business to users of a social network, the system comprising a processor and associated memory device for storing a series of instructions to cause the processor to carry out a method according to the following steps:

establishing a closed user group comprising a plurality of users of the social network, wherein eligibility for membership of the closed user group requires satisfying at least one eligibility criterion;

receiving a business registration request from a business wishing to promote a good or service to members of the closed user group, the business registration request including at least one discount offered by the business to members of the closed user group;

generating a discount coupon to be redeemed upon a member of the closed user group purchasing the good or service from the business;

storing the discount coupon in a database; and

querying the database for discount coupons offered to the closed user group for retrieval and display to any user who is a member of the closed user group.

The system may further include means for downloading a discount coupon for printing or storage on a personal storage device to facilitate subsequent redemption.

In one embodiment, the step of querying the database involves retrieving one or more user preferences provided in a user registration request, the user preferences including at least one category in relation to which the user wishes to receive notification of discounts.

The system may further include means for broadcasting notifications of discounts to members of a closed user group in accordance with user preferences associated with each member.

The notifications may be transmitted via SMS, email, live feed or notifications.

In one form of the invention, the user preferences include a location associated with the user so that only notifications relating to discounts relevant to the location associated with the user will be provided to the user.

### BRIEF DESCRIPTION OF THE DRAWINGS

The invention will now be described in further detail by reference to the accompanying drawings. It is to be understood that the particularity of the drawings does not supersede the generality of the preceding description of the invention.

FIG. 1 is an example system for implementing the method of the present invention according to an embodiment of the invention.

FIG. 2 is a flowchart illustrating operation of the method of the present invention according to an embodiment of the invention.

FIG. 3 is a screen view showing a sample home page according to an embodiment of the invention.

FIG. 4 is a screen view showing a sample user's personal home page according to an embodiment of the invention.

FIG. 5 is a screen view showing a sample business detail page according to an embodiment of the invention.

FIG. 6 is a screen view showing a closed user group detail page according to an embodiment of the invention.

FIG. 7 is a screen view showing a sample search facility according to an embodiment of the invention.

FIG. 8 is a screen view showing a sample of search results according to an embodiment of the invention.

FIG. 9 is a screen view showing a sample discount coupon according to an embodiment of the invention.

FIG. 10 is a screen view showing a number of discount coupons downloaded according to an embodiment of the invention.

FIG. 11 is a screen view showing a user profile according to an embodiment of the invention.

FIG. 12 is a screen view showing a sample group management page according to an embodiment of the invention.

FIG. 13 is a screen view showing a sample user inbox according to an embodiment of the invention.

FIG. 14 is a screen view showing a sample invitation prompt according to an embodiment of the invention.

FIG. 15 is a screen view showing a sample business profile according to an embodiment of the invention.

FIG. 16 is a screen view showing a sample group administration page according to an embodiment of the invention.

FIG. 17 is a screen view showing a sample business landing page according to an embodiment of the invention.

FIG. 18 is a screen view showing a sample group landing page according to an embodiment of the invention.

FIG. 19 is a screen view showing a sample iphone landing page according to an embodiment of the invention.

FIG. 20 is a screen shot showing a sample widget landing page according to an embodiment of the invention.

FIG. 21 is a screen shot showing a sample button landing page according to an embodiment of the invention.

FIG. 22 is a schematic diagram showing various functional elements of the computer-enabled system of FIG. 1 in block form.

### DETAILED DESCRIPTION

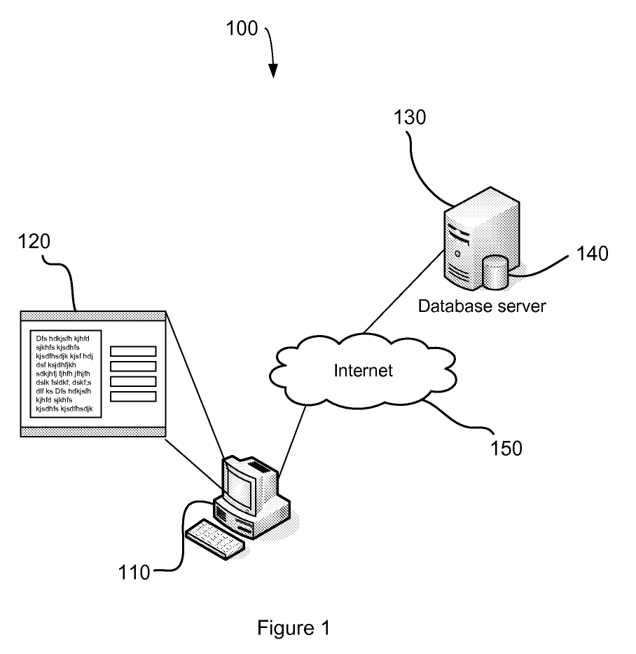

Referring firstly to FIG. 1, there is shown an example system for implementing aspects of the method of the present invention. The system 100 includes a client user device 110 providing a graphic user interface 120, and a database 140 in communication with the server 130 and the client user terminal 110. The client user device 110 and server 130 are interconnected by means of a communications network 150 such as the Internet or any other suitable network. The client user device 130 may comprise any electronic device operable to send and receive requests, messages, or information over a communications network 150. Examples of such client user devices include personal computers, cell phones, handheld messaging devices, laptop computers, personal data assistants, and the like.

Almost every person has a social network including the person's family, friends, colleagues, acquaintances, etc. Some people have large social networks, whereas others interact with smaller numbers of intimate and close family members and/or friends. Some people are very active within their social networks, maintaining close contacts with their acquaintances and regularly communicating with them via various channels. Other people are less sociable and interact with their acquaintances only on rare occasions.

Social networking services enable users to create a personal profile, and make it easier to keep in touch with the users social network be it large or small. Social networks can be broken down into two broad categories: internal social networks and external social networks. An internal or closed social network is a private community that consists of a group of people who share a common link such as employment within a company, membership of an association, society, being a student associated with a particular education provider. Alternatively, an internal or closed social network might be established as an “invite only” group created by a user in an external social network. In contrast an external social network is open or public and available to all web users. Open or external social networks may be targeted to users which share a particular interest, but participation is not restricted.

Some social networks have become targets for advertisers which can use the popularity of a social network to distribute advertising and promotional content to a large number of individuals at minimal cost. For users the distribution of advertising and promotional content or material via a social networking service may in itself provide an incentive to participate in a social network since it provides a means of discovering information regarding new products and services. This incentive may be heightened by offering a discount or other form of offer.

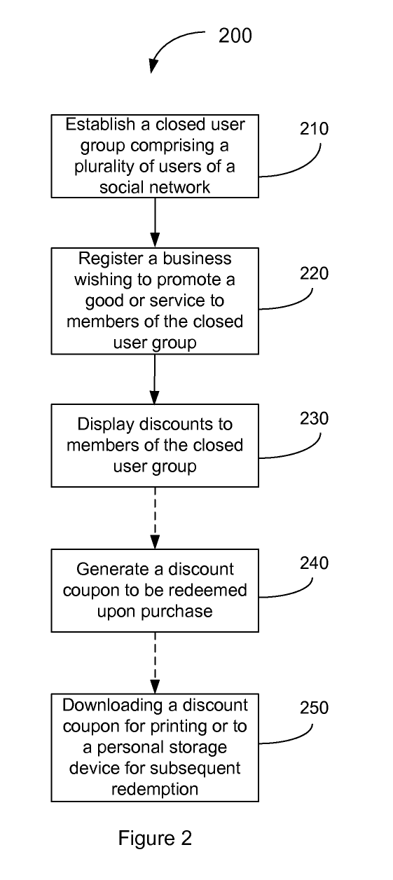

Referring to FIG. 2, there is shown a flowchart which illustrates the operation of a method 200 for promoting a business to members of a social network in accordance with the present invention. At step 210, a closed user group comprising a plurality of users of a social network is established. Typically, eligibility for membership of the closed user group requires satisfying at least one eligibility criterion such as membership of a particular organisation, sharing of a common interest, being a student associated with a particular education provider or employment within a particular company.

At step 220, a business wishing to promote a good or service to members of the closed user group is registered as a member of the social network. The registration request provided on behalf of the business must include a discount offered by the business to members of the closed user group. Means are provided for conducting searches for discounts offered to a particular closed user group for display to any user who is a member of the closed user group. Searches may be initiated on demand by a user, or may be programmed to automatically retrieve and distribute discount notifications or feeds. At step 230, the discounts are displayed to members of the closed user group.

Optionally, at step 240, a discount coupon may be generated to represent include a discount offered by the business to members of the closed user group to be redeemed upon a member of the closed user group purchasing the good or service from the business. Moreover, optionally, at step 250, the discount coupon is downloaded by a member of the closed user group for printing or storage on a personal storage device to facilitate subsequent redemption.

In regard to the discount offered by the business to members of the closed user group, it is to be understood that a “discount” comprises any reduction in price whether offered as a percentage, or dollar reduction in an original price, or in the form of a discount offer including a two for the price of one, buy one get one free, three for the price of two type offer.

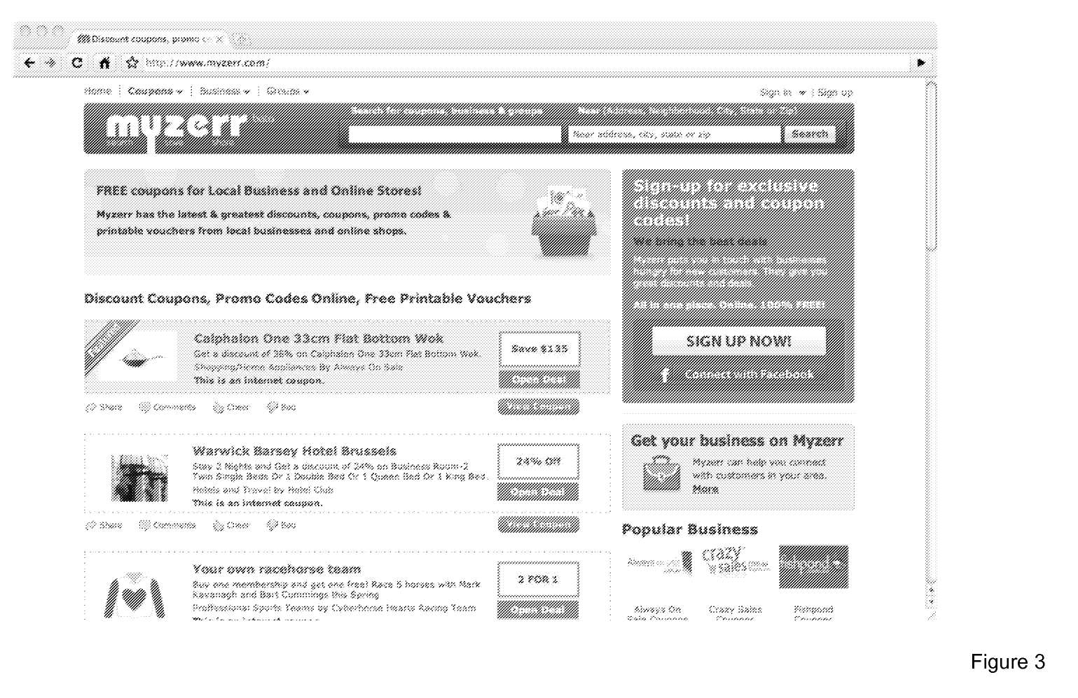

Referring now to FIG. 3, there is shown a screen view showing a sample home page according to an embodiment of the invention. The main home page is a typical “welcome” page which includes links to facilities for joining as a user of the social network and links to a coupon summary page, a business summary page and a group's summary page. If a current user is not logged in, the home page displayed is the main home page shown in FIG. 3. The main home page also includes a search feature which enables users to search for coupons, businesses and groups associated with certain localities.

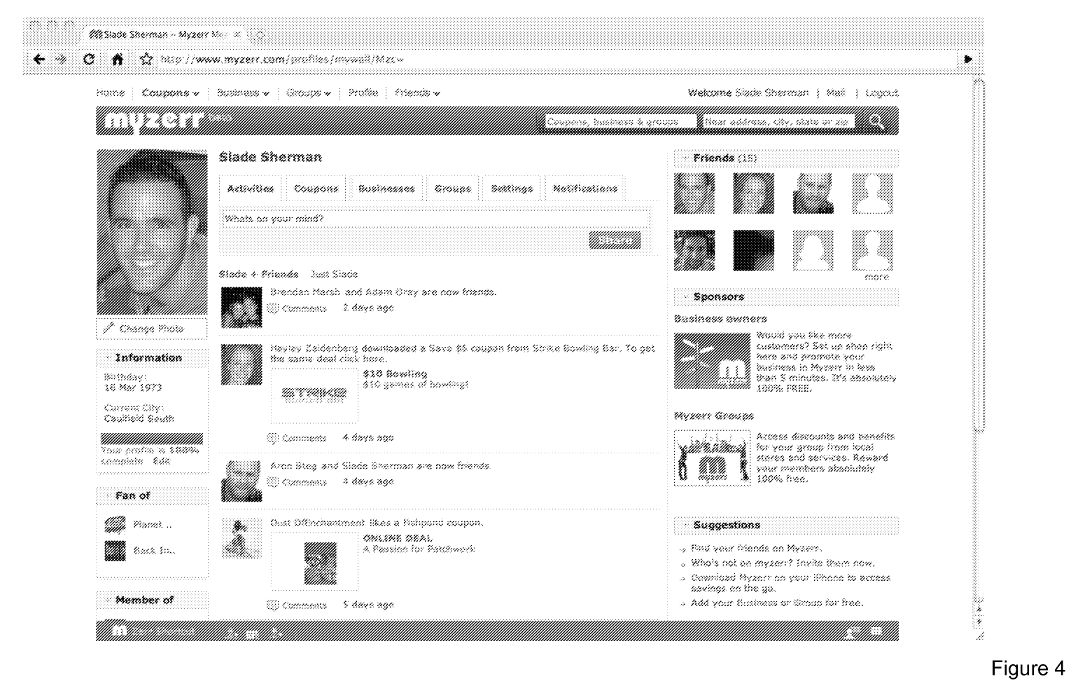

If the user is logged in, the home page displayed to the user is the user's personal home page as shown in FIG. 4. The content of the user's personal home page will vary depending on the status of the user as a regular member, business, or group. Only a registered user can access their personal home page. An option exists for users, businesses and groups to construct a profile that will be public however the fields visible to the public are restricted.

The content displayed on the user's personal home page is tailored to the user who has logged in. For instance, the user's personal home page includes links to an activities tab which displays recent activities of registered user's classified as “friends” on the site, a coupons tab which displays a list of coupons which may be of interest to the registered user, a businesses tab which displays a list of businesses which may be of interest to the registered user, a groups tab which displays a list of groups that the user is a member of, as well as group information and any discounts on offer, a settings tab which enables the user to view and edit information in their profile and a notifications tab which displays mail, notifications and requests directed to the user. There is also a sign out link which upon activation returns the user to the main home page.

The coupons tab on the user's personal home page includes a summary of discounts available. The summary list is associated with a filter, displays the location of the user and provides sort options, by popularity, by age of offer or by offer features. The summary of discounts includes a display of the number of prints of each discount as an indicator of popularity, and links to a detail page associated with the business offering the discount. There are also options enabling the user to add comments, share, cheer or boo (i.e. rate) or delete a coupon.

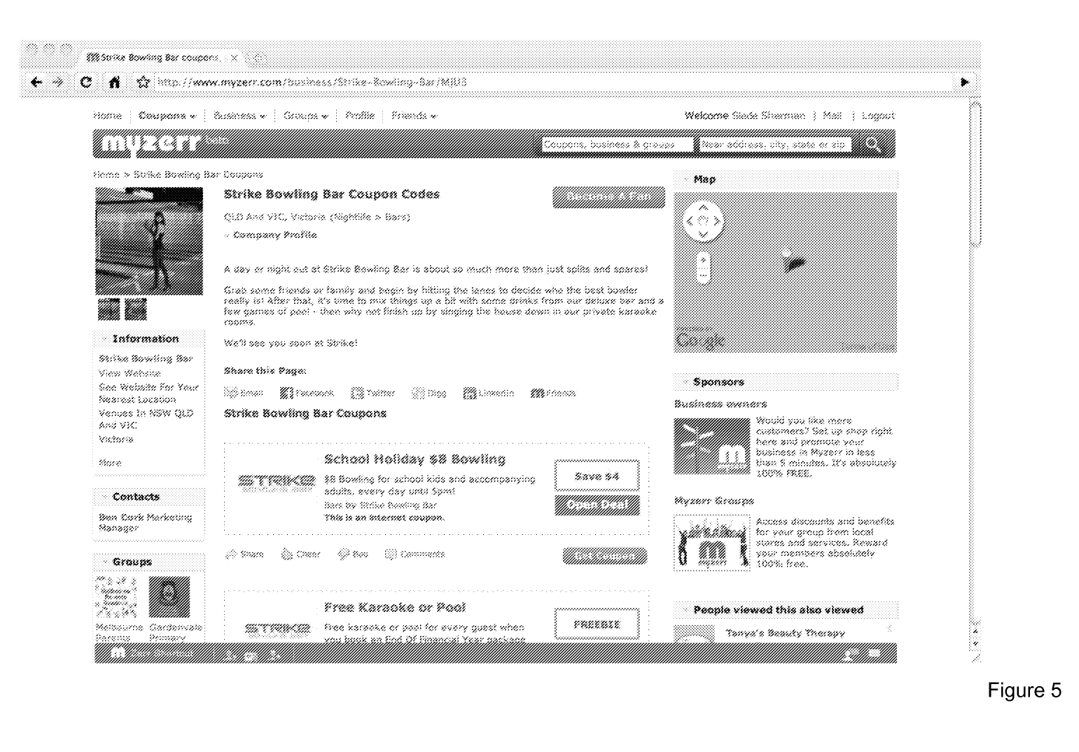

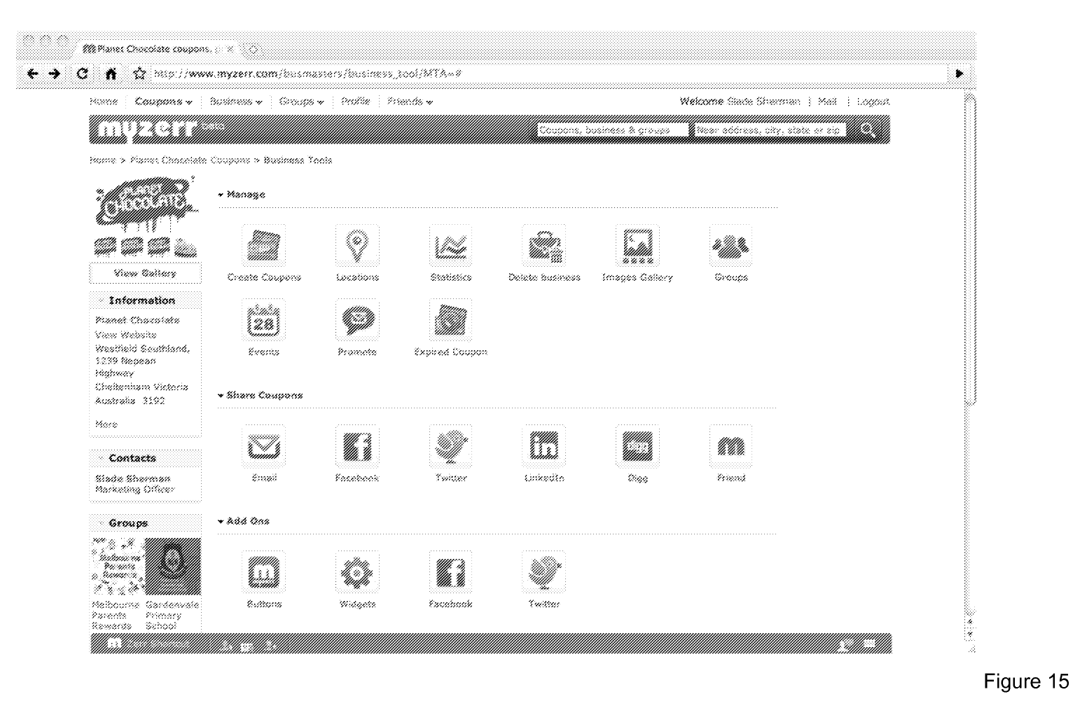

Referring now to FIG. 5, there is shown the business detail page shown when a user selects a link to a detail page associated with the business offering a discount. The detail page includes information regarding the business and discounts offered by the business, a “get coupon” button which enables the user to print a coupon or download the coupon to their mobile phone or other electronic personal storage device such as a PDA. The page further indicates which group memberships are eligible for each discount, an offer rating, and a map showing the location of the business. The content is populated by the business when they sign up to promote on the social network. The business can maintain and edit the content through the business administration page which is shown in FIG. 15.

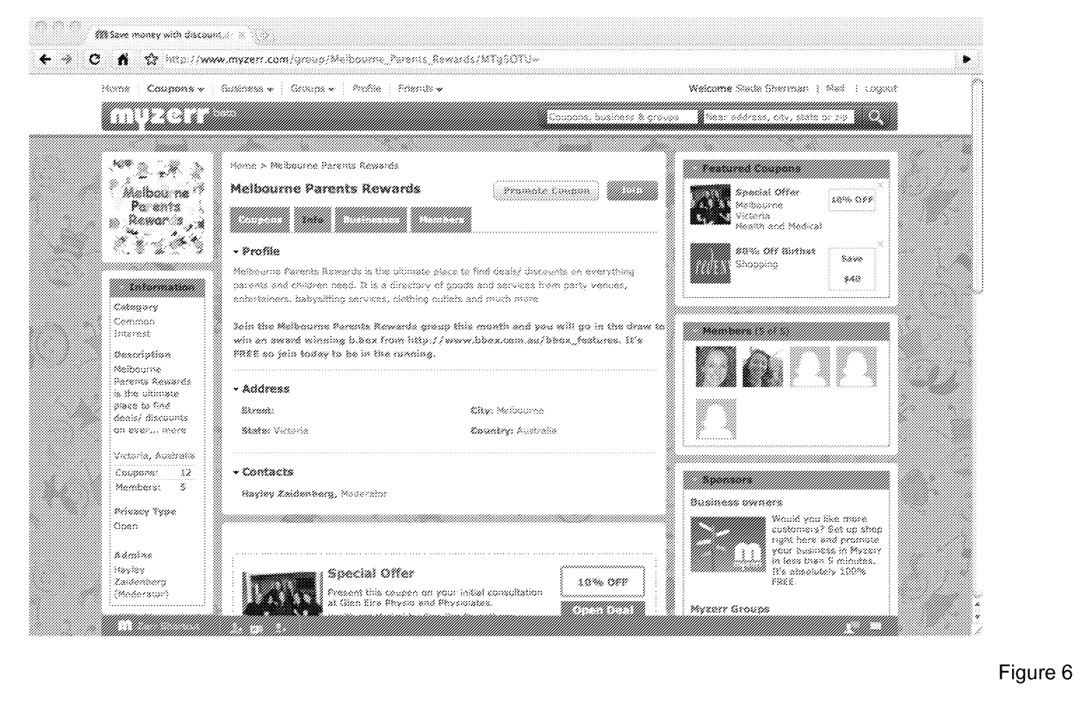

Referring now to FIG. 6, there is shown a user group detail page. This page is very similar in format to the business detail page shown in FIG. 5 but its content is directed to a particular group. The closed user group detail page is maintained by a group administrator and displays content about the group including any eligibility criteria, and discounts offered to members of the group by partner businesses. Links are provided so that a user viewing the group detail page can send a request to join the group, view group comments, view group promotions, or share the group detail page with others. The join group link provides details on group eligibility requirements. For example, if the user is over the age of 55, the user is eligible to join the Seniors Group, however, for a group such as “Monash Students”; the user would need to provide evidence to the group administrator that the user is indeed a Monash student. There is also a section for a news feed based on group members and a section for group comments and discussion.

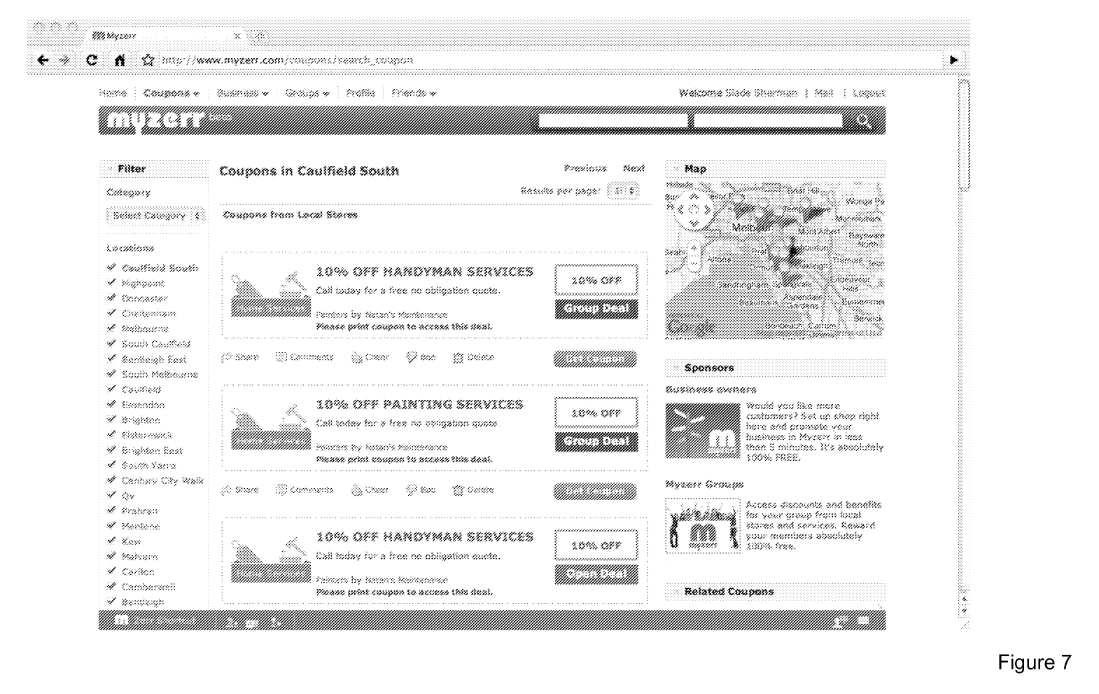

Referring now to FIG. 7, there is shown the search facility. The search facility can be accessed from most pages on the website and provides for searching for coupons, businesses and groups, e.g. by keyword. The search filter enables sorting of search results via the Group Index A-Z and other users, e.g. by name or email address. The filter requests entry of the user's location by city or postcode. Preferably, the location is saved as a default so that when a particular user is logged in, that location is assumed. Facility is also provided to search and save based on a category, e.g. food & wine, travel, events, leisure, home, retail, entertainment and computers which may be selected from a drop down box. Similarly, searches can be conducted by keywords. The keywords may be saved as a default search query for a particular user. This enables registered users to setup their search preferences so that any discounts displayed upon login will match the default search preferences. Users can also edit their default search preferences at any time by entering and saving the new preferences, or may conduct alternative searches by simply entering alternative preferences without saving.

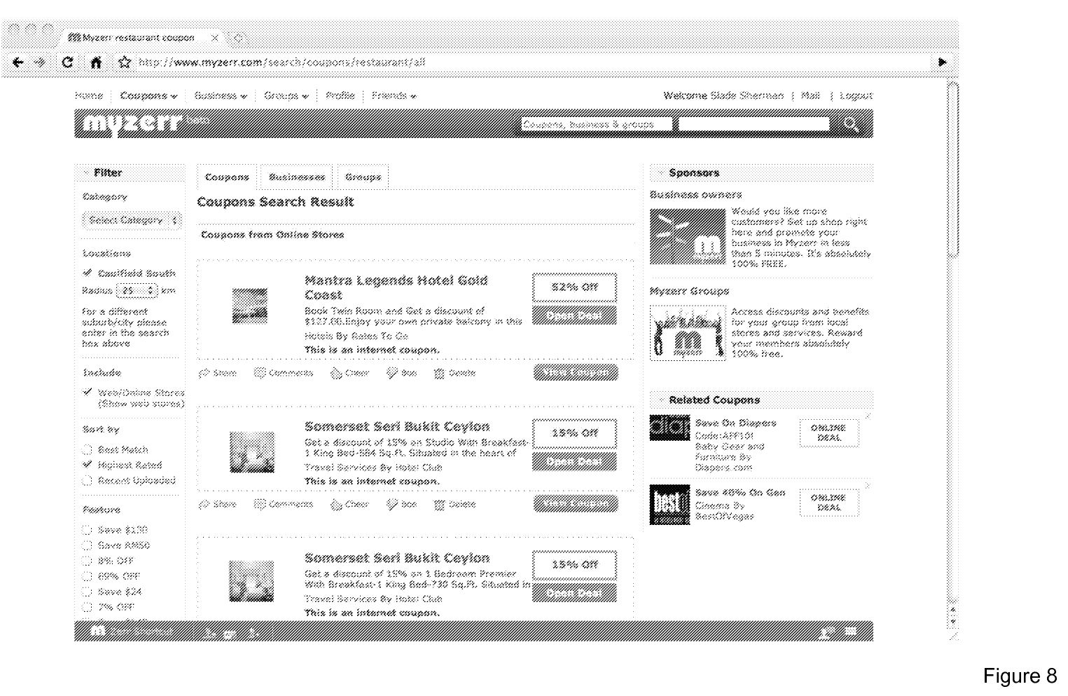

Referring now to FIG. 8, there is shown a screen view showing a sample of search results. The results of a search are displayed as a list of businesses matching the search query together with an electronic map which indicates the location of each business. In the event that no business matches the current search preferences the user is presented with a form that enables the user to invite a business to join the social network and offer discounts to members of a particular group or otherwise. Any user that invites a business to join the social network receives one or more social credits.

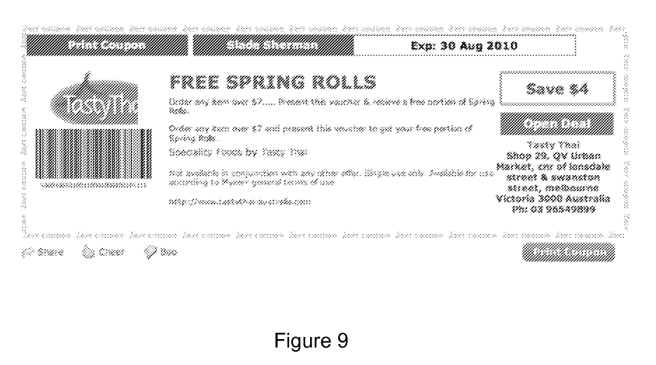

Referring now to FIG. 9, there is shown a sample discount coupon. The discount coupon is automatically generated by populating a generic template with data retrieved from the business profile and database, including business contact details and a description of the discount offer. The coupon may be printed, or downloaded for storage on a personal storage device. Each coupon preferably includes a barcode to be scanned on redemption. There is also an option to share the offer with other users or to rate the offer.

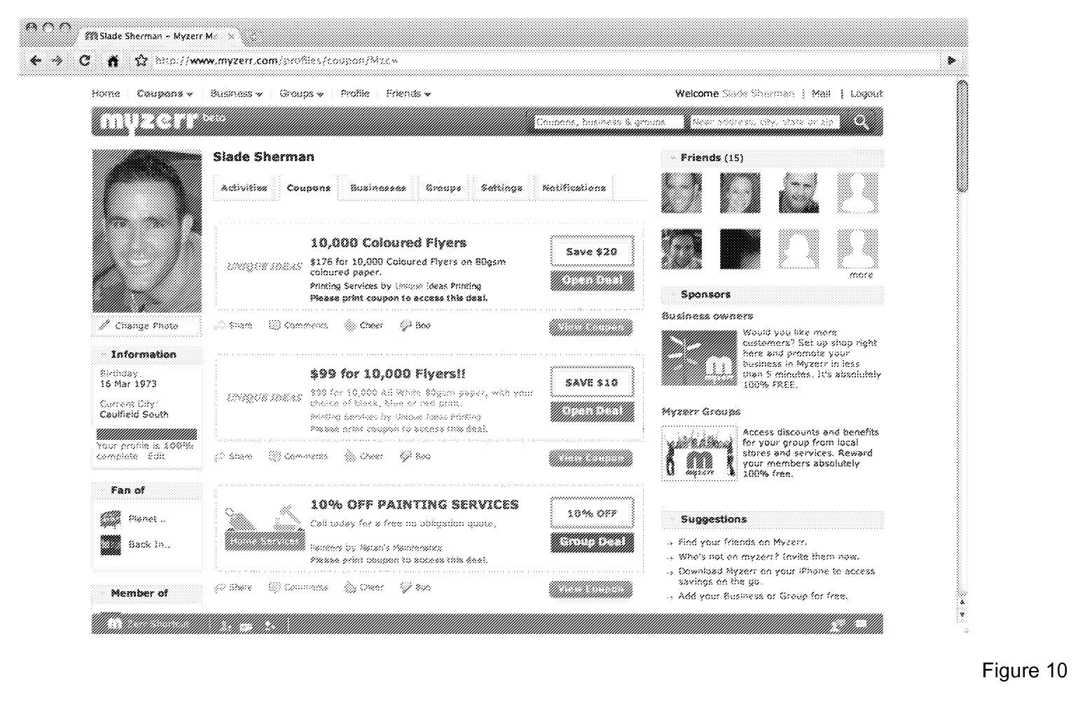

Referring now to FIG. 10 there is shown the downloaded coupons page displayed when the user selects the coupons tab. This feature enables a user to download coupons directly without first viewing business details. Once in the downloaded coupons page, the user is presented with options to obtain further information on a particular coupon and business, view a coupon in more detail, and adjust viewing preferences including the maximum number of coupons on a single page.

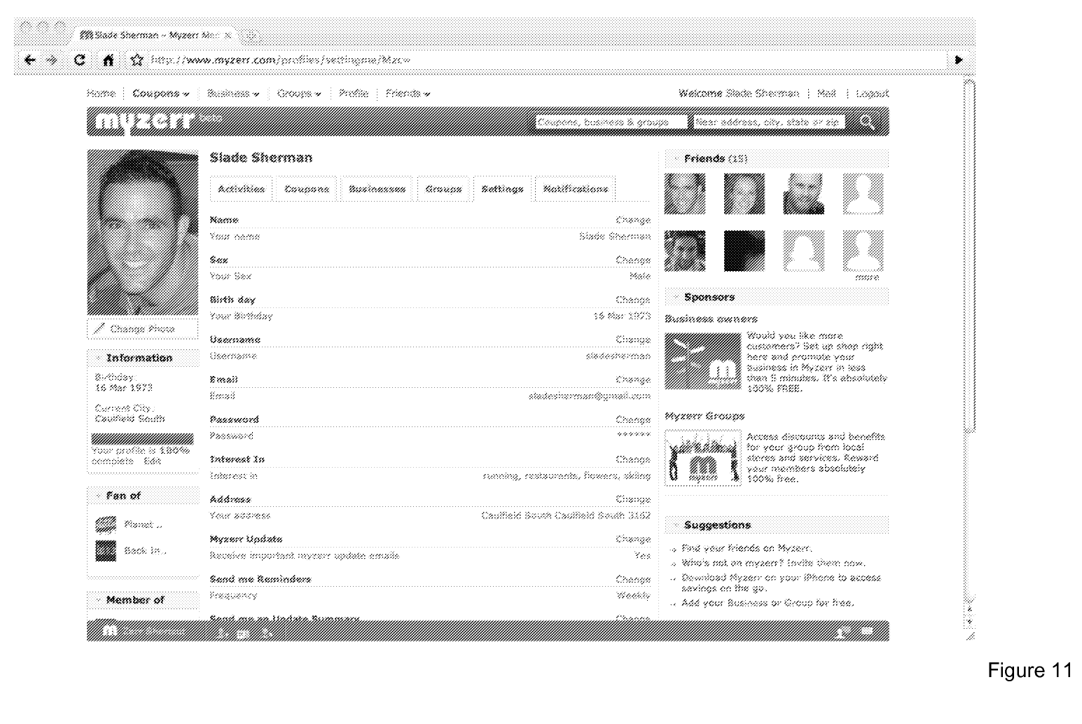

Referring now to FIG. 11, there is shown a personal profile page which enables the user to view and edit information and settings associated with their profile. The view discount coupons link displays to the user their coupon preferences and a list of any coupons that the user has selected as favourites. The notifications tab directs the user to their personal inbox. Shortcuts are also provided to either add a group or business, or invite a group or business. The personal profile page also includes an indicator of the user's social credit rating, for example shown in smiley faces. This rating may be based on time as a member, the number of invitations sent, usage, and the like. The profile is associated with a number of tabs including a settings tab which enables the user to view and edit settings of discounts and notifications, and via privacy settings to control access to the user profile, in regard to who can search for the user, who can view various aspects of the user's profile and how and by whom the user can be contacted.

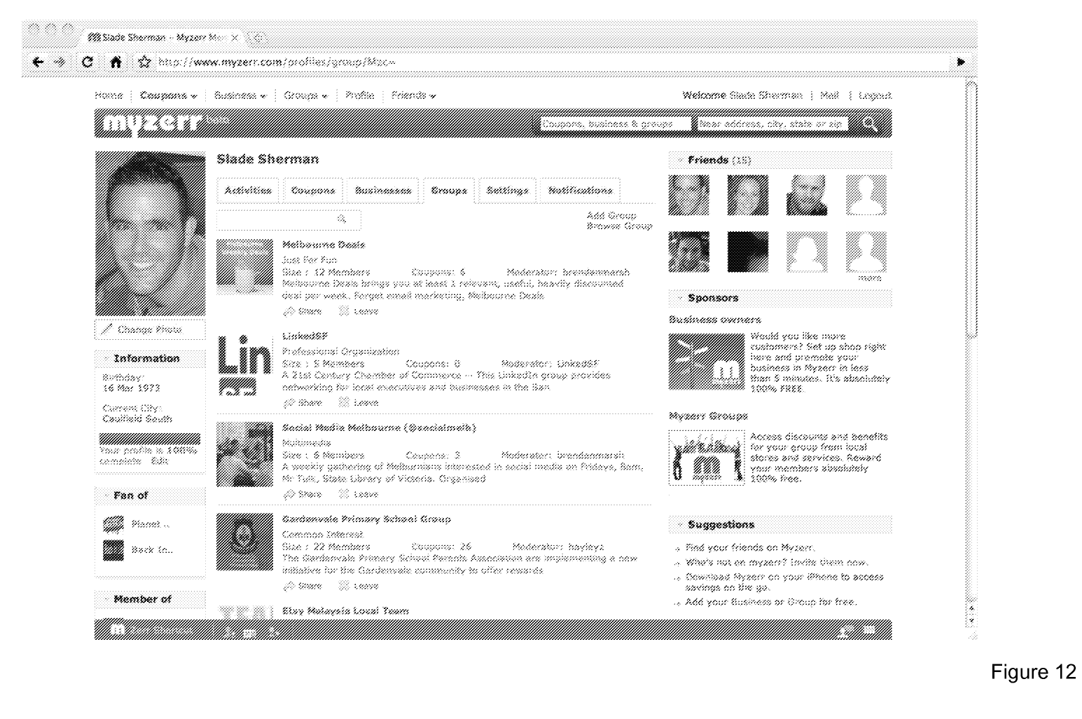

Referring now to FIG. 12, there is shown the manage groups page displayed when the user selects the coupons tab via the user's personal home page or the groups menu. This page is designed to enhance the user's interaction with and management of relationships with one or more groups. The manage groups page displays information including user information based on the user profile page, group information, sponsored links (i.e. paid advertising) and a find a group function. Users are provided with options for adding a group, suggesting a business for introduction to the group, and changing group settings. The add a group feature is accompanied by a browse group feature to enable a user to check whether a proposed group already exists on the social network and a function whereby the user is appointed as group administrator. A suggest a business feature includes a facility for inviting a business that the user wishes to introduce to the group and to suggest discounts to businesses and groups. A change group settings feature enables a user to dictate feed settings for the group. In the group information section, links are provided to discounts offered to the group, a newsfeed, updates, view group members, view group events, add and share options, as well as a leave group option.

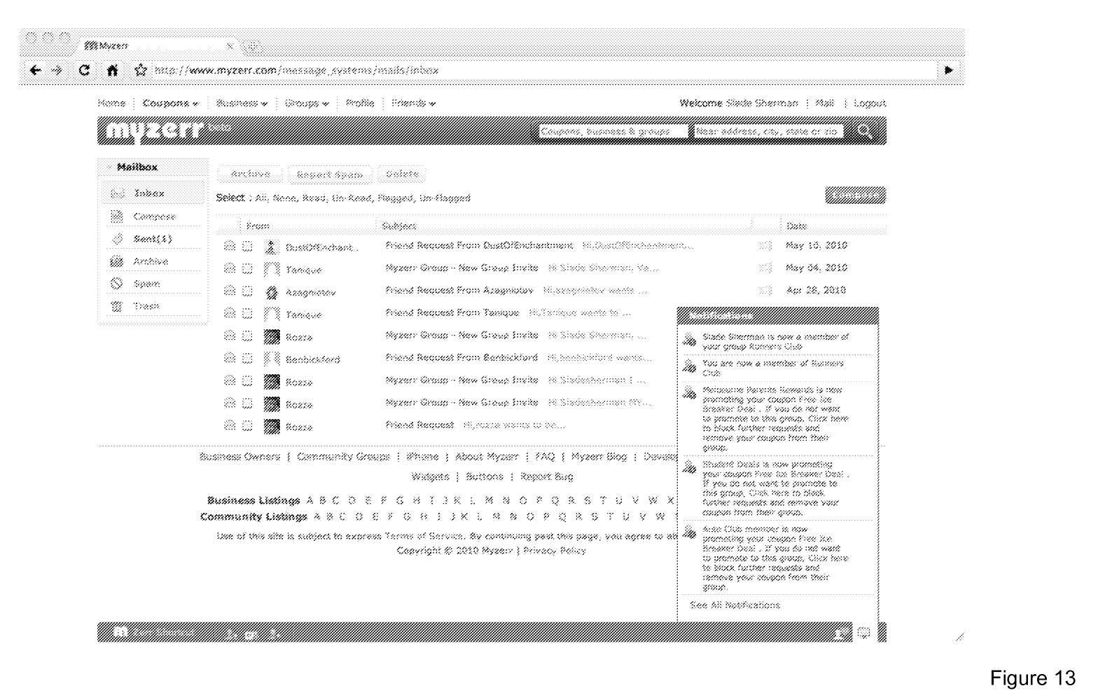

Referring now to FIG. 13, there is shown a user inbox displayed when the user selects the notifications tab via the user's personal home page. Any notifications or other electronic mail is directed to the user through the user's inbox. A create mail function for composing and sending messages is also provided. Notifications are generated by the system to notify the user whenever some action involving the user occurs. For example, the user may be notified if any one of the following events occurs:
Message sent
Added as a friend
Connected to user as a fan
Confirm a friendship request
Asked to confirm friend detail
Request to list user as a group member
Suggested a friend to the user
Added a fried suggested by the user
Someone the user knows joins the social network
Someone the user knows is on the social network
Someone the user knows has a birthday coming up
Invitation to join group
Promotion of the user to an officer
Join the user as a group administrator
Request to join a group of which the user is the group administrator
Reply to a user discussion board post
Change to the name of a group to which the use belongs
Invitation to join a business
Make the user a page administrator
Suggest a discount to the user
Suggest a group to the user
Invitation to an event
Change the date or time of an event
Cancel and event
Make the user an event administrator
Request to join an event of which the user is an administrator
Changes to the name of an event of which the user is an administrator
Comments on the user
Other updates from the social network

A registered user may also be notified of some or all of these actions via the activities tab displayed when the user selects the notifications tab via the user's personal home page as shown in FIG. 4.

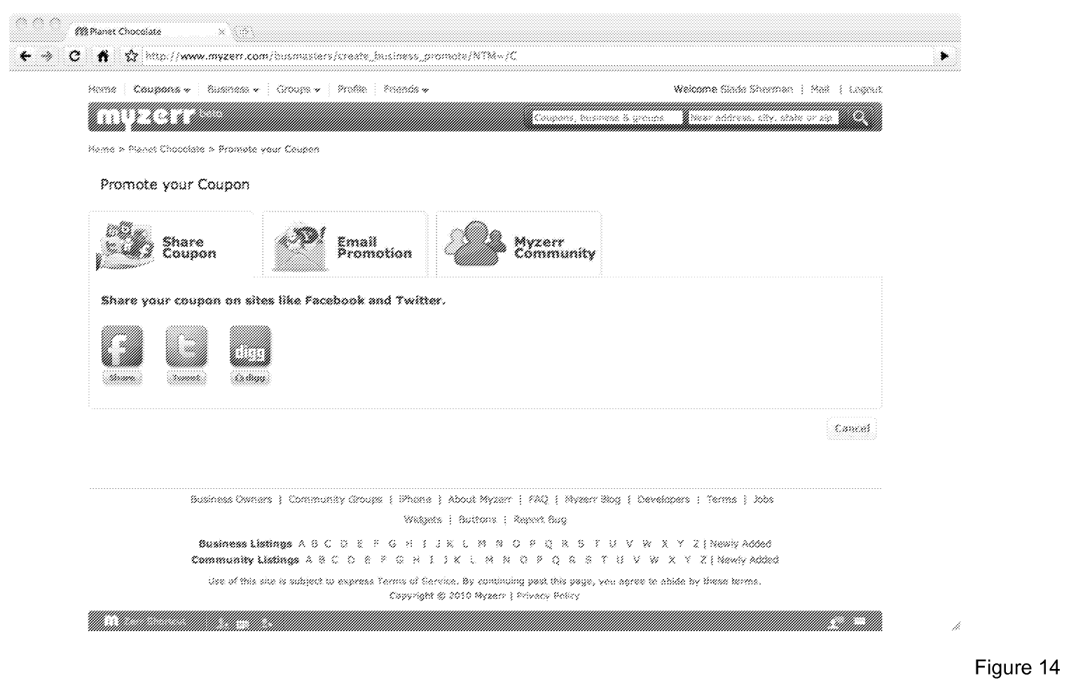

Referring now to FIG. 14, there is shown an invitation wizard page which enables the user to easily share information regarding businesses, groups and friends as well as events and promotions. The tools provided on the invitation wizard page enable bulk upload and multiple invites for a number of friends; management of the invitation process including emails and URL tracking of responses for ease of sign up for those accepting the invitation; recognition of sign up of an invitee; automatic relationship linking between the inviter and the invitee; flexible upload options that are easy to use; XLS and CSV invite process; and social media invites and sharing through add this and RSS feeds.

Referring now to FIG. 15, there is shown an example of a business administration page. Preferably, businesses incur no cost for registering as a user of the social network for promotional purposes. Current users can easily set up a business registration and distribute adverting and promotional content to other users of the social network, provided that a discount is offered to fellow users. The business has control over what the offer is, the expiry of the offer, to whom, e.g. whether a particular group or groups, friends of all users are eligible to receive the offer. Offers can be easily communicated to the target audience using electronic mail, feeds or the broadcasting function. As an alternative to email, offers can be disseminated to users using other social networking sites such as Facebook, Twitter and LinkedIn.

The business administration page may include an indicator of the business's rating, for example shown in smiley faces. This business rating is based on ratings provided by users and/or the number of offers made to users, and the like. Lists of friends who have nominated the business as a favourite, and groups to whom the business has offered a discount are also provided. Businesses are provided with notifications of comments and reviews made by users of the social network as well as feeds indicating the number of users viewing and downloading particular discount coupons.

It may further be desirable to provide cost per click advertising as another means for businesses to promote their business via the social network. Tracking functionality is provided to enable businesses to monitor whether ads are being displayed; return on advertising investment; tracking click; and monitoring which promotions generate the most activity.

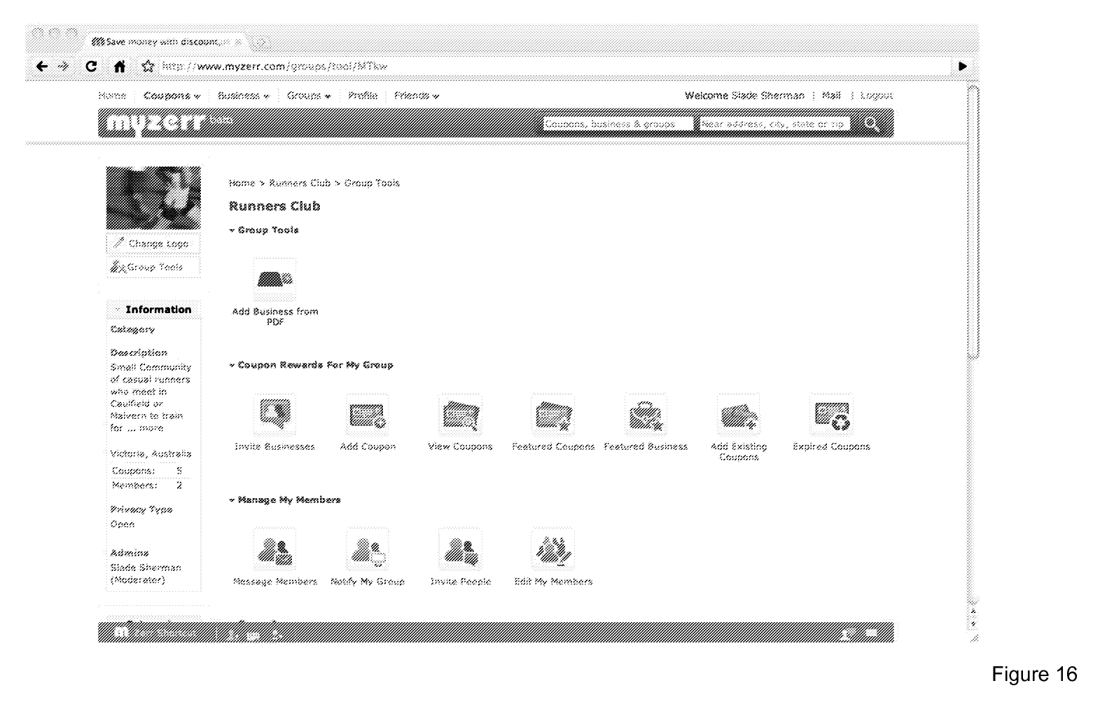

Referring now to FIG. 16, there is shown an example of a group administration page. Only a group administrator, or person authorised by the group administrator can access the group administration page for a particular group. The group administration page provides tools which enable the group administrator to control what discounts are displayed to group members; issue invitations to businesses to offer discounts to group members; the order in which any discounts on offer to members of the group are displayed; view and edit group member contacts; coordinate communications to group members; manage group member access; and promotion of group offers managed by the group. For example, a student union may list the union bookshop and on campus dining offers or an association may list discount offered on journal relevant to members of that association.

The group administration page format largely mirrors that of the business administration page described with reference to FIG. 15. A menu is provided to enable management of discounts offered to members of the group including provision for the addition of new providers and sorting the order in which discounts appear on display, whether retrieved by feed settings, search query or other means. The invite tab enables invitations to be prepared and sent to businesses that may wish to promote to the group regardless of the membership status of the business. Tools are also provided to promote the benefit of membership to businesses that are not already online.

A group mailbox facility facilitates communications with group members and partner businesses. An add a group event link enables group event to be scheduled, e.g. school fete, shopping events for group members, i.e. “family and friends shopping night”. A group social ranking may be displayed on the group administration page and is based on reviews by group members as well as time established and level of activity.

The group information box provides access to basic group information which can be edited and updated by the group administrator. This includes detail selected from drop down boxes, eg. city, country, group type (e.g. non-profit, alumni, corporate, conference, networking, professional, employee, local trader, student, sports club, union, common interest, etc.), access and approval (i.e. required or not). A group description is also provided. A settings tab provides access to the group settings, e.g. electronic signature, group visibility, group access rules, location, language, discount categories and web page addition. A business tab enables administration of business partners, i.e. tools for connecting and inviting new businesses, links to existing partner businesses and tools for excluding businesses. A members tab enables communication with group members, editing of members communications and feed setting, and social network status updates that link to e.g. Facebook and group feeds. An invite tab provides access to tools which assist the group in extending invitations to both potential users and businesses.

The system contemplates different types of user groups, for example, user groups which comprise users and their friends, extended user group which comprises users and the friends plus their friend's friends, formal user groups which are by invitation only, and business groups which are administrated by a business user who invites customers.

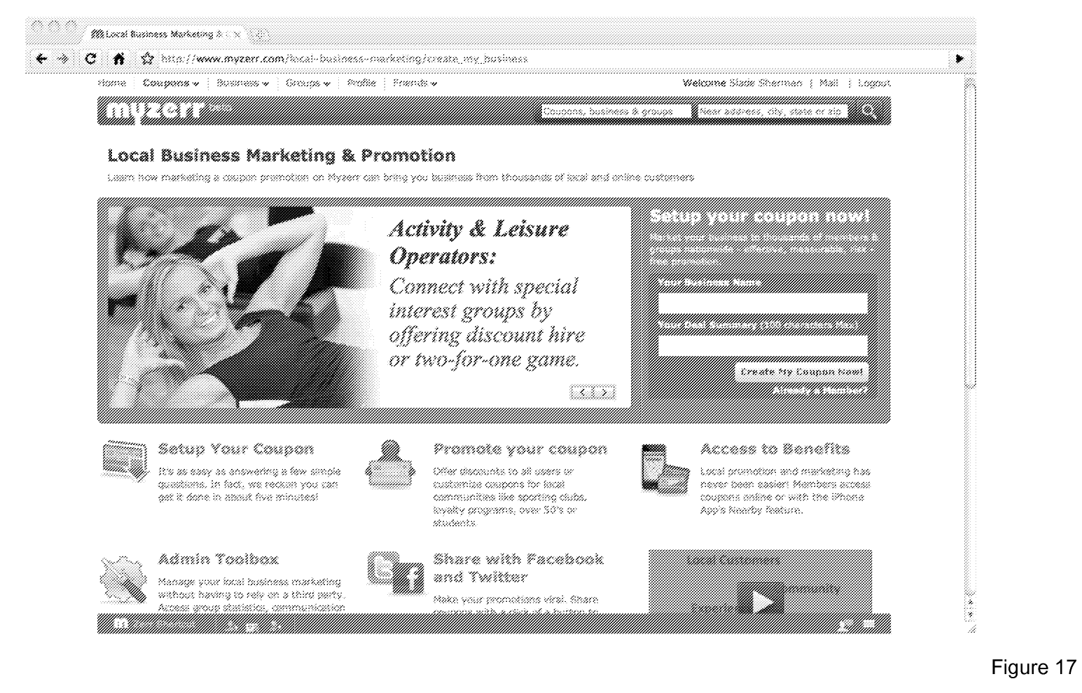

FIG. 17 is a screen view showing a sample business landing page which can be accessed from various pages on the site including the home page shown in FIG. 3. This page provides ready access the tools for preparing and distributing advertising and promotional content to other users of the social network as described with reference to FIG. 15.

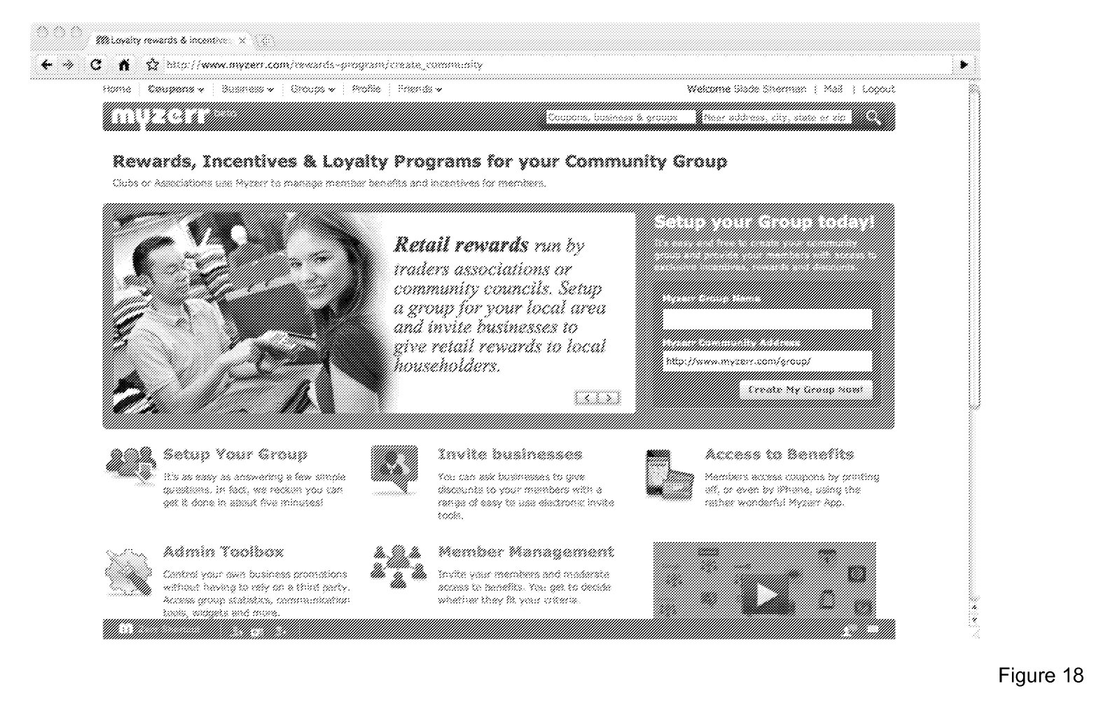

FIG. 18 is a screen view showing a sample group landing page which can be accessed from various pages on the site including the home page shown in FIG. 3. This page provides ready access the tools for managing offers made to group members amongst other tings as described with reference to FIG. 16.

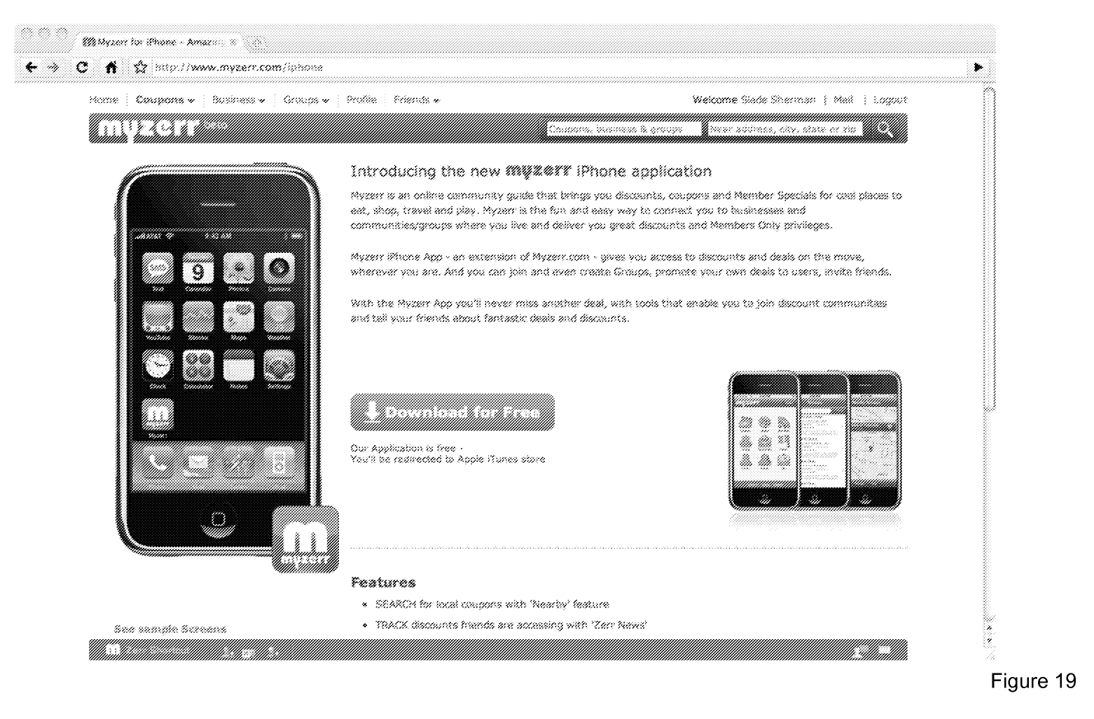

FIG. 19 is a screen view showing a sample iphone landing page which can be accessed from various pages on the site including the home page shown in FIG. 3. This page enables a user to download the application to their iphone to provide access to discounts and offers on the move.

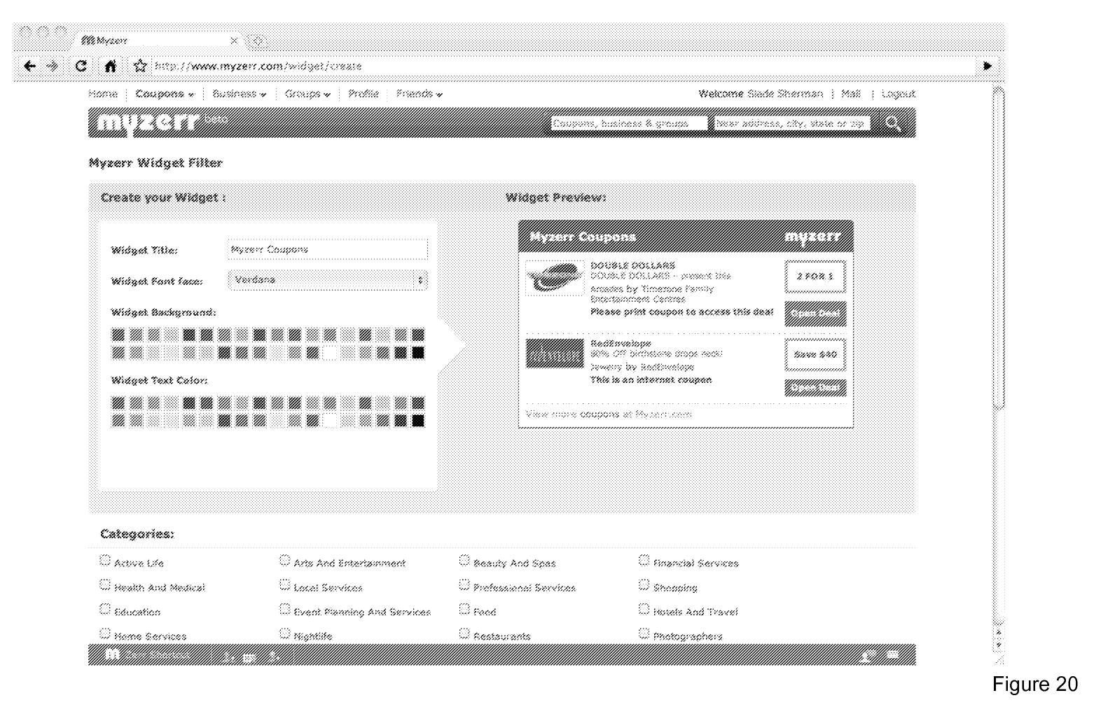

FIG. 20 is a screen shot showing a sample widget landing page which can be accessed from various pages on the site including the home page shown in FIG. 3. The widget page includes tools for creating and editing a widget which can be used to add colour and appeal to coupons.

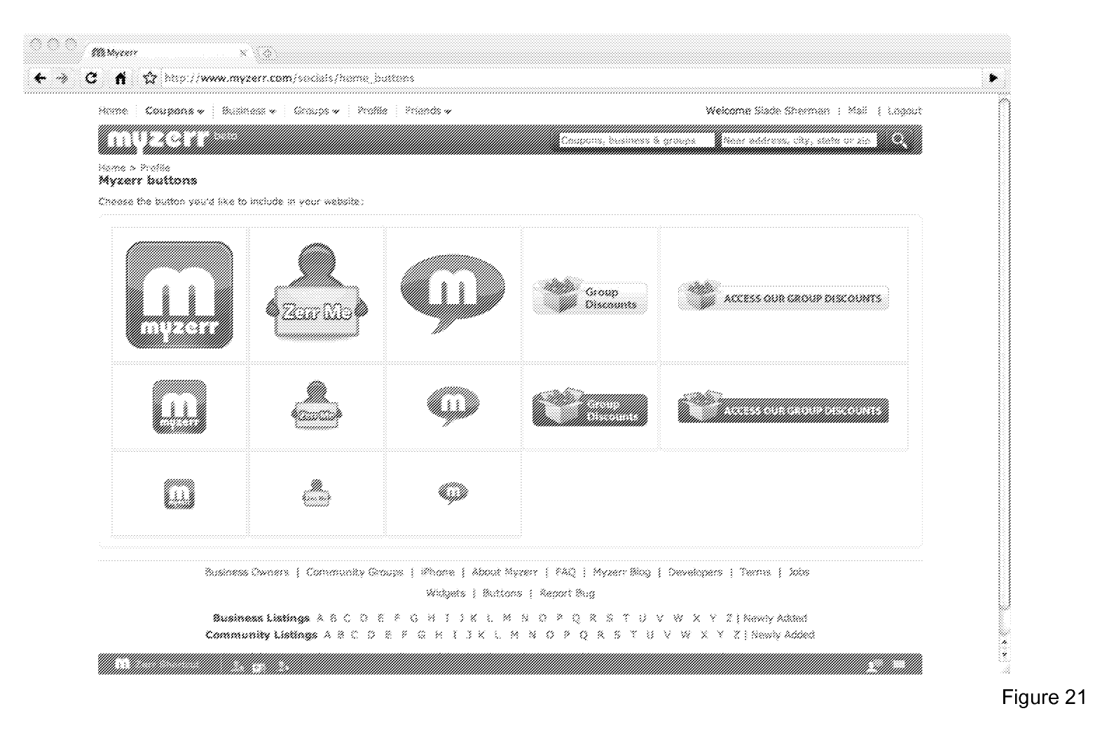

FIG. 21 is a screen shot showing a sample button landing page which can be accessed from various pages on the site including the home page shown in FIG. 3. The button page includes a series of buttons which users may add to their own webpages to create a link to certain features of the social networking site.

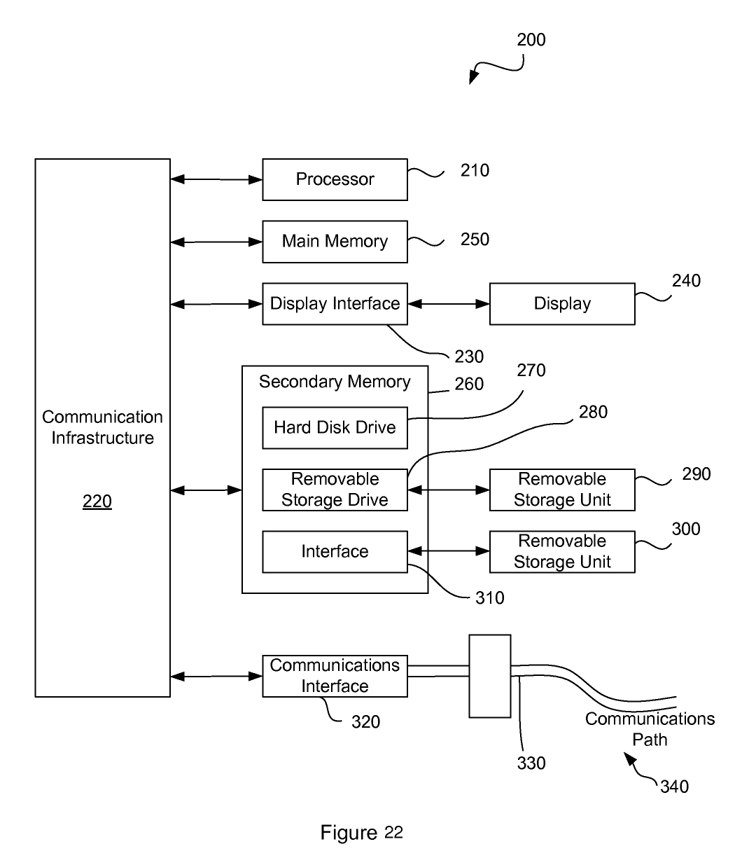

Referring now to FIG. 22, the method may be implemented using hardware, software or a combination thereof and may be implemented in one or more computer systems or processing system. In particular, the functionality of the client user terminal and its graphic user interface, as well as the server may be provided by one or more computer systems capable of carrying out the above described functionality.

The computer system 200 includes one or more processors, such as processor 210. The processor 210 is connected to a communication infrastructure 220. The computer system 200 may include a display interface 230 that forwards graphics, texts and other data from the communication infrastructure 220 for supply to the display unit 240. The computer system 200 may also include a main memory 250, preferably random access memory, and may also include a secondary memory 260.

The secondary memory 260 may include, for example, a hard disk drive 270, magnetic tape drive, optical disk drive, etc. The removable storage drive 280 reads from and/or writes to a removable storage unit 290 in a well known manner. The removable storage unit 290 represents a floppy disk, magnetic tape, optical disk, etc.

As will be appreciated, the removable storage unit 290 includes a computer usable storage medium having stored therein computer software in a form of a series of instructions to cause the processor 210 to carry out desired functionality. In alternative embodiments, the secondary memory 260 may include other similar means for allowing computer programs or instructions to be loaded into the computer system 200. Such means may include, for example, a removable storage unit 300 and interface 310.

The computer system may also include a communications interface 320. Communications interface 320 allows software and data to be transferred between the computer system and external devices. Examples of communication interface 320 may include a modem, a network interface, a communications port, a PCMIA slot and card etc. Software and data transferred via a communications interface 320 are in the form of signals 330 which may be electromagnetic, electronic, optical or other signals capable of being received by the communications interface 320. The signals 330 are provided to communications interface 320 via a communications path 340 such as a wire or cable, fibre optics, phone line, cellular phone link, radio frequency or other communications channels.

Although in the above described embodiments the invention is implemented primarily using computer software, in other embodiments the invention may be implemented primarily in hardware using, for example, hardware components such as an application specific integrated circuit (ASICs). Implementation of a hardware state machine so as to perform the functions described herein will be apparent to persons skilled in the relevant art. In other embodiments, the invention may be implemented using a combination of both hardware and software.

The targeting of advertising and promotional content to users of a social network is advantageous to the recipients and the suppliers of the content as well as groups who facilitate communication access by partner businesses to their members. For recipients it represents a way to discover discounts offered on products and services and facilitates sharing information with others. Moreover it provides an added incentive to belonging to particular groups. For businesses that supply the products or services on offer, it represents a way to increase revenue by attracting new customers to the product or service. Advertising also serves to inform existing users and potential new users about new or improved products or services. Targeted content may also be used to strengthen the business relationship with, and customer satisfaction of existing customers.

While the invention has been described in conjunction with a limited number of embodiments, it will be appreciated by those skilled in the art that many alternative, modifications and variations in light of the foregoing description are possible. Accordingly, the present invention is intended to embrace all such alternative, modifications and variations as may fall within the spirit and scope of the invention as disclosed.

The present application may be used as a basis or priority in respect of one or more future applications and the claims of any such future application may be directed to any one feature or combination of features that are described in the present application. Any such future application may include one or more of the following claims, which are given by way of example and are non-limiting in regard to what may be claimed in any future application.

1. A method for promoting a business to users of a social network, the method including the following steps:
establishing a closed user group comprising a plurality of users of the social network, wherein eligibility for membership of the closed user group requires satisfying at least one eligibility criterion;
registering as a member of the social network a business wishing to promote a good or service to members of the closed user group, a business registration request including at least one discount offered by the business to members of the closed user group; and
displaying discounts offered to the closed user group to any user who is a member of the closed user group.

2. A method according to claim 1, further including the step of generating a discount coupon to be redeemed upon a member of the closed user group purchasing the good or service from the business.

3. A method according to claim 2, further including the steps of the user selecting a discount of interest and downloading a discount coupon for printing or storage on a personal storage device to facilitate subsequent redemption.

4. A method according to claim 1 further including the step of the user indicating one or more user preferences including at least one category in relation to which the user wishes to receive notification of discounts.

5. A method according to claim 4, further including the step of broadcasting notifications of discounts to the members of a closed user group in accordance with user preferences associated with each member.

6. A method according to claim 4, wherein the user preferences include a location associated with the user so that only notifications relating to discounts relevant to the location associated with the user will be provided to the user.

7. A method according to claim 4, wherein in the event that no discounts matching the user preferences are identified, the user is presented with an option to invite a local business to become a member of the social network and offer a discount to the closed user group.

8. A method according to claim 7, wherein a user who invites a business to become a member of the social network receives one or more social credits.

9. A system for promoting a business to users of a social network, the system comprising a processor and associated memory device for storing a series of instructions to cause the processor to carry out a method according to the following steps:
establishing a closed user group comprising a plurality of users of the social network, wherein eligibility for membership of the closed user group requires satisfying at least one eligibility criterion;
receiving a business registration request from a business wishing to promote a good or service to members of the closed user group, the business registration request including at least one discount offered by the business to members of the closed user group;
generating a discount coupon to be redeemed upon a member of the closed user group purchasing the good or service from the business;
storing the discount coupon in a database; and
querying the database for discount coupons offered to the closed user group for retrieval and display to any user who is a member of the closed user group.

10. A system according to claim 9, the system further including means for downloading a discount coupon for printing or storage on a personal storage device to facilitate subsequent redemption.

11. A system according to claims 9, wherein the step of querying the database involves retrieving one or more user preferences provided in a user registration request, the user preferences including at least one category in relation to which the user wishes to receive notification of discounts.

12. A system according to claim 11, further including means for broadcasting notifications of discounts to members of a closed user group in accordance with user preferences associated with each member.

13. A system according to claim 12, wherein the notifications are transmitted via SMS, email, or live feed.

14. A system according to claim 11, wherein the user preferences further include a location associated with the user so that only notifications relating to discounts relevant to the location associated with the user will be provided to the user.
